(19) United States
(12) Patent Application Publication
(10) Pub. No.: US 2026/0210147 A1
(43) Pub. Date: Jul. 23, 2026

(54) TARP SET MOUNTABLE TO VEHICLE

(71) Applicants: TOYOTA JIDOSHA KABUSHIKI KAISHA, Toyota-shi, Aichi-ken (JP); Snow Peak, Inc., Sanjo-shi, Niigata (JP)

(72) Inventors: Motoyasu MORI, Nagoya-shi (JP); Mitsuki SUGAYA, Toyota-shi (JP); Osamu WATANABE, Toyota-shi (JP); Shotaro INOUE, Nisshin-shi (JP); Ryotaro TAKAMI, Okazaki-shi (JP); Lisa YAMAI, Sanjo-shi (JP)

(73) Assignees: TOYOTA JIDOSHA KABUSHIKI KAISHA, Toyota-shi, Aichi-ken (JP); Snow Peak, Inc., Sanjo-shi, Niigata (JP)

(21) Appl. No.: 18/881,282

(22) PCT Filed: Jul. 4, 2023
(86) PCT No.: PCT/JP2023/024814

§ 371 Date: Jan. 4, 2025

(30) Foreign Application Priority Data
Jul. 5, 2022 (JP) 2022-108437

(51) Int. Cl. E04H 15/06; E04H 15/60; E04H 15/64

(52) U.S. Cl. CPC E04H 15/06; E04H 15/60; E04H 15/64

(57) ABSTRACT

The present description provides a tarp set that can provide a large shaded area when mounted to a vehicle. The tarp set disclosed in the present description includes a side pole, a ridge pole, and a tarp. The side pole is mountable to an inner surface of the back door when the back door is open and extending in a left-right direction of the vehicle. The ridge pole extends from the back door in a rear direction of the vehicle. The tarp is connectable to both ends of the side pole and a rear end of the ridge pole and hanging down on both sides of the ridge pole. This tarp set can provide a large shaded area around the opened back door by including the side pole extending to sides of the vehicle and the ridge pole extending rearward.

### REFERENCE TO RELATED APPLICATION

This application is a related application of Japanese Patent Application No. 2022-108437 filed on Jul. 5, 2022 and claims priority thereto, the contents of which are hereby incorporated by reference into the present application.

The technology disclosed in the present description relates to a tarp set mountable to a vehicle.

### BACKGROUND ART

### Technical Field

A tarp set mountable to a rear gate (flip-up back door) of a vehicle is described in Japanese Patent Application Publication No. 2020-158009. The tarp set described in Japanese Patent Application Publication No. 2020-158009 directly mounts a tarp to the back door.

### Summary of Invention

The tarp set described in Japanese Patent Application Publication No. 2020-158009 cannot provide a large shaded area since the tarp is directly mounted to the back door. The present description proposes a tarp set that can provide a large shaded area.

In a first aspect disclosed in the present description, a tarp set comprises a side pole, a ridge pole, and a tarp. The side pole is mountable to an inner surface of a back door when the back door is open and extends in a left-right direction of a vehicle. The ridge pole extends from the back door in a rear direction of the vehicle. The tarp is connectable to both ends of the side pole and a rear end of the ridge pole and hangs down on both sides of the ridge pole. This tarp set comprises the side pole extending in the lateral direction of the vehicle and the ridge pole extending in the rear direction, and thereby provides a large shaded area around the opened back door. The ridge pole may be connected to the side pole via a joint.

In a second aspect disclosed in the present description, the side pole of the tarp set according to the first aspect includes a center pole and a pair of end poles. The center pole is fixable to the back door. The pair of end poles is detachably attachable to respective ends of the center pole. An entirety of the center pole is located within an outline of the back door. Once the end poles are detached, the back door can be closed with the center pole fixed thereon. A large shaded area can be provided by opening the back door, attaching the end poles to the center pole, attaching the ridge pole, and attaching the tarp to these poles.

The tarp set may further comprise a holder for holding the end poles detached from the center pole along the center pole. When the tarp set is not in use, the pair of end poles can be held on the inner side of the back door.

In a third aspect disclosed in the present description, the tarp set according to the first or second aspect further comprises a striker bracket mounted on the ridge pole. The striker bracket is engageable with a latch located in the back door. When the back door is closed, the latch of the back door engages with a striker hook provided on a rear floor. The ridge pole can be firmly fixed to the back door by using the latch of the back door.

In a fourth aspect disclosed in the present description, the tarp set according to the third aspect further comprises a rotary joint for rotatable connection of the ridge pole to the side pole. The rotary joint allows the ridge pole to rotate around an axis of the side pole. The striker bracket engages with the latch when the ridge pole is rotated towards the latch. The striker bracket can be easily engaged with the latch by rotating the ridge pole rearward and upward after the ridge pole has been connected to the side pole.

In a fifth aspect disclosed in the present description, the tarp set according to any one of the first to fourth aspects may further comprise a frame for supporting the tarp. A center of the frame is connectable to the ridge pole and both ends of the frame contact a ground. Attaching the tarp to the frame prevents the tarp from flapping in the wind. The frame may have an inverted V shape or an inverted U shape.

Details of the technique disclosed herein and further developments will be described in the following detailed description.

### BRIEF DESCRIPTION OF DRAWINGS

FIG. 1 shows a tarp set according to an embodiment mounted on a vehicle, viewed diagonally from behind;

FIG. 2 shows a rear view of the tarp set according to the embodiment mounted on the vehicle

FIG. 3 shows an inner surface of a back door (with end poles attached to a center pole);

FIG. 4 shows the inner surface of the back door (with the end poles detached from the center pole);

FIG. 5 shows a cross-sectional view along a line V-V in FIG. 4;

FIG. 6 shows a side view of the back door with a side pole and a ridge pole mounted thereon;

FIG. 7 shows the inner surface of the back door (with a rotary joint according to a variant);

FIG. 8 shows a cross-sectional view along a line VIII-VIII in FIG. 7; and

FIG. 9 shows the cross-sectional view along a line VIII-VIII in FIG. 7 (with the rotary joint rotated rightward).

### DESCRIPTION OF EMBODIMENT

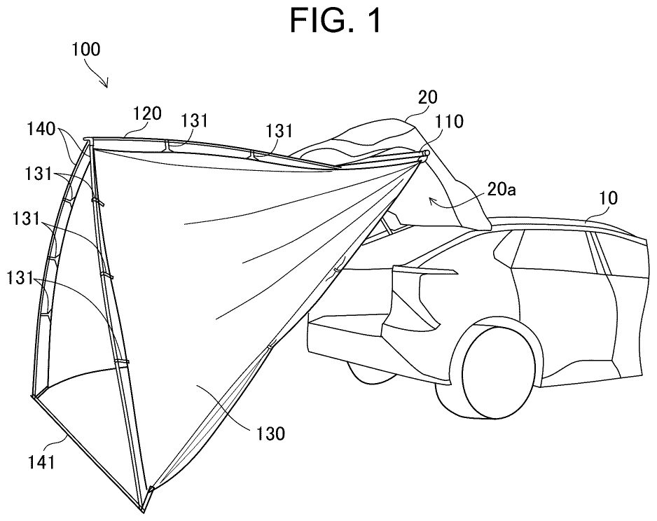

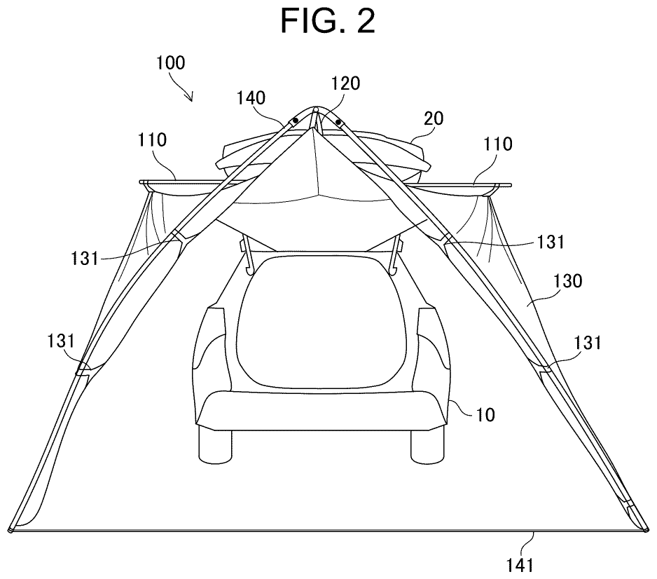

A tarp set 100 according to an embodiment is described with reference to the drawings. FIG. 1 shows the tarp set 100 mounted on a vehicle 10, viewed diagonally from behind. FIG. 2 shows a rear view of the tarp set 100 mounted on the vehicle 10.

The tarp set 100 is mountable to a flip-up back door 20. The flip-up back door means a door that covers a rear opening of the vehicle, includes hinge(s) at its upper end, and is rotatable around the hinge(s) such that the lower end of the door is moved upward.

The tarp set 100 includes a side pole 110, a ridge pole 120 connected to the side pole 110, a frame 140 connected to the rear end of the ridge pole 120, and a tarp 130.

The side pole 110 is mountable to an inner surface 20a of the back door 20. Here, the “inner surface” of the back door 20 means the surface of the back door 20 directed toward the vehicle interior when the back door 20 is closed. The inner surface 20a of the back door 20 may be called a back door trim. The side pole 110 extends in a vehicle width direction of the vehicle 10. The overall length of the side pole 110 is greater than the width of the vehicle 10.

The front end of the ridge pole 120 is connected to the side pole 110 via a joint, which will be described later in detail. When the back door 20 is open, the ridge pole 120 extends in a rear direction of the vehicle. The tarp 130 is connected to both ends of the side pole 110 and the rear end of the ridge pole 120.

A plurality of ring tabs 131, which are aligned in line, is attached in a center portion of the tarp 130, and the ridge pole 120 is inserted through the tabs 131 so that the tarp 130 is hung from the ridge pole 120. A ridge line of the tarp is formed along the ridge pole 120. Once the tarp 130 is hung from the ridge pole 120, the tarp 130 hangs down on both sides of the ridge pole 120.

The frame 140 is an inverted V-shaped beam, its center (the flexure of the V shape) is connected to the rear end of the ridge pole 120, and the both ends of the frame 40 contact the ground.

It is desirable that the both ends are fixed to the ground with pegs. The frame 140 also supports the tarp 130. A plurality of tabs 131 is attached along two rear edges of the tarp 130, and the frame 140 is inserted through the tabs 131 so that the frame 140 supports the tarp 130 at its rear edges.

The both ends (lower ends) of the frame 140 are tied with a string 141. Tying the both ends with the string 141 defines the distance between the both ends of the frame 140. The frame 140 supports the rear end of the ridge pole 120 from below. The height position of the rear end of the ridge pole 120 can be adjusted by adjusting the distance between the both ends of the frame 140.

The tarp set 100 can provide a large shaded area by attaching the tarp 130 to the side pole 110 extending in a left-right direction of the back door 20 and the ridge pole 120 extending rearward from the back door 20.

Attaching the rear edges of the tarp 130 to the frame 140 prevents the tarp 130 from flapping in the wind.

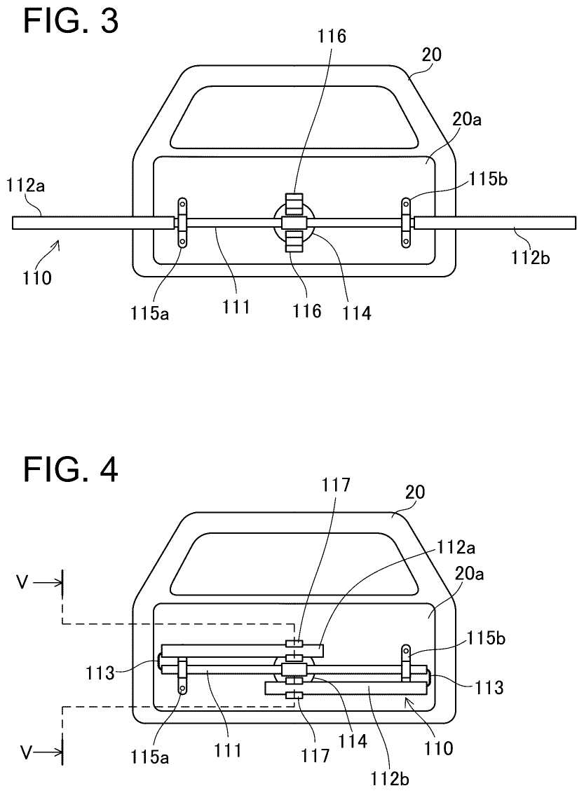

The side pole 110 is described in further detail. FIGS. 3 and 4 show the inner surface 20a of the back door 20. The side pole 110 is mounted on the inner surface 20a. The side pole 110 includes a center pole 111 and a pair of end poles 112a, 112b. The end poles 112a and 112b are detachably attachable to respective ends of the center pole 111. FIG. 3 shows the center pole 111 with the end poles 112a, 112b attached thereto, and FIG. 4 shows the center pole 111 with the end poles 112a, 112b detached therefrom. In FIGS. 3 and 4, a rotary joint 121, which will be described later, is not shown.

The center pole 111 is fixable to the inner surface 20a of the back door 20 via a center bracket 114 and retaining brackets 115a, 115b.

The inner diameter of the end pole 112a (112b) is equal to the outer diameter of the center pole 111, and the end pole 112a (112b) is insertable to an end of the center pole 111.

The end pole 112a (112b) is detached from the center pole 111 simply by being pulled. An end of the end pole 112a (112b) is connected to its corresponding end of the center pole 111 via a rubber string 113, and thus the detached end pole 112a (112b) is not distanced apart from the center pole 111.

Two holders 116 are provided on the center bracket 114. The holders 116 are located just above and just below the center pole 111. After detached from the center pole 111, the end pole 112a (112b) can be held by a holder 116. The end pole 112a (112b) in the holder 116 is held parallel to the center pole 111 above (below) the center pole 111.

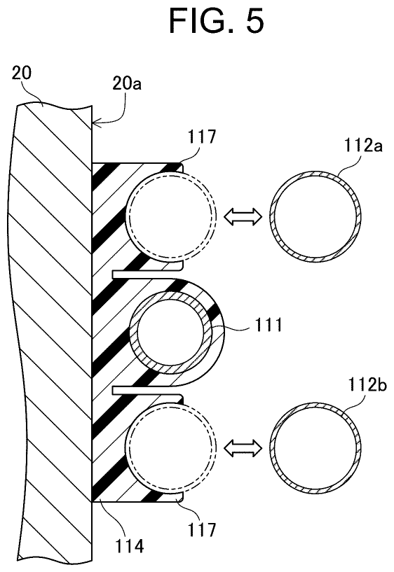

FIG. 5 shows a cross-sectional view along a line V-V in FIG. 4. The center bracket 114 is constituted of a resin. Each holder 116 on the center bracket 114 has a U shape and holds the end pole 112a (112b) when the end pole 112a (112b) is pressed thereinto.

As shown in FIG. 4, the entirety of the center pole 111 is located within the outline of the back door 20. Once the end poles 112a, 112b are detached and held by the holders 116, the back door 20 can be closed. The vehicle 10 can travel with the center pole 111 and the end poles 112a, 112b attached on the inner surface 20a of the back door 20.

The ridge pole 120 can be divided into a plurality of short poles, although this is not shown. The frame 140 can also be divided into a plurality of short poles. The ridge pole 120 and the frame 140 are easy to store since they can be divided into short poles.

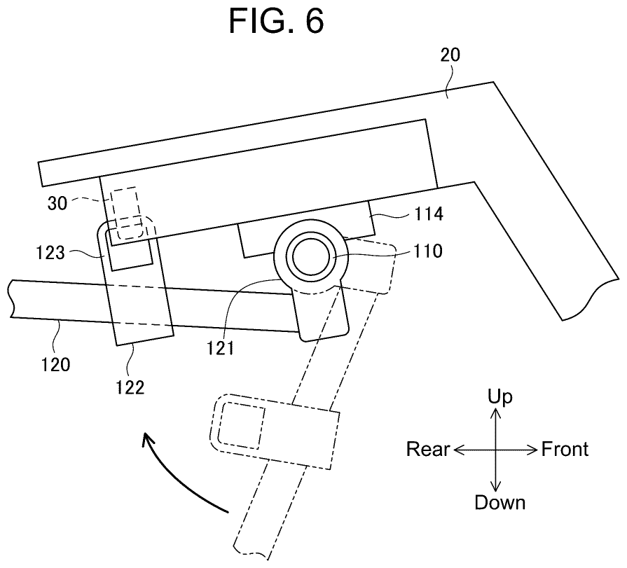

The connection between the side pole 110 and the ridge pole 120 is described. FIG. 6 shows a side view of the back door 20 with the side pole 110 connected to the ridge pole 120. FIG. 6 shows the back door 20 opened. Only a part of the back door 20 (in the vicinity of the center bracket 114 on which the side pole 110 is attached) is shown in FIG. 6. In FIG. 6, the center bracket 114 is depicted in a simplified manner and the holders 116 shown in FIGS. 3 and 4 are not shown.

The ridge pole 120 is connected to the side pole 110 via a rotary joint 121. The rotary joint 121 connects the ridge pole 120 such that the ridge pole 120 intersects the side pole 110. The ridge pole 120 is detachably attachable to the rotary joint 121. When the tarp set 100 is not in use, the ridge pole 120 is detached from the rotary joint 121. To assemble the tarp set 100, an end of the ridge pole 120 is inserted in the rotary joint 121.

The rotary joint 121 allows the ridge pole 120 to rotate around the axis of the side pole 110. The rotary joint 121 and the ridge pole 120 before rotated are shown with two-dot chain lines in FIG. 6.

A striker bracket 122 is mounted on the ridge pole 120. The striker bracket 122 is provided with a hook 123. A mechanism to lock a closed door is called “a striker”, and the striker is comprised of a striker hook located on a vehicle body and a latch located on a door. When the door is closed, the latch engages with the striker hook and thus the door is locked in the closed state. A latch 30 is also embedded in a lower portion of the back door 20. A striker hook (not shown) is provided at a rear end of rear floor of the vehicle body. When the back door 20 is closed, the latch 30 engages with the striker hook and thus the back door 20 is locked in the closed state. Detailed depiction and description of the latch 30 are omitted since its configuration is well known.

The hook 123 of the striker bracket 122 has the same shape as the striker hook described above. As the ridge pole 120 is rotated from its position indicated by the two-dot chain line in a direction indicated by the bold line in FIG. 6, the hook 123 (the striker bracket 122) finally engages with the latch 30. In other words, when the ridge pole 120 is rotated toward the latch 30, the striker bracket 122 (the hook 123) engages with the latch 30. When the hook 123 of the striker bracket 122 is engaged with the latch 30 of the back door 20, the rotation of the ridge pole 120 is prohibited. Since the ridge pole 120 is supported by the back door 20 at two sites via the rotary joint 121 and the striker bracket 122, the ridge pole 120 is firmly held by the back door 20.

As described above, the center of the frame 140 is connected to the rear end of the ridge pole 120. The both ends of the frame 140 contact the ground. Since the frame 140 supports the rear end of the ridge pole 120, the back door 20 on which the ridge pole 120 is fixed is prevented from moving down.

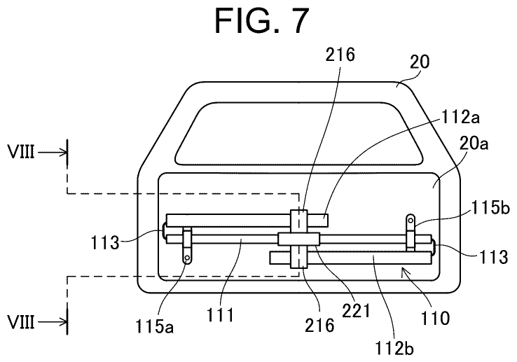

(Variant of Rotary Joint) Referring to FIGS. 7 to 9, a rotary joint 221 according to a variant described. The rotary joint 221 according to the variant has the function of the center bracket 114 described above. That is, the rotary joint 221 connects the ridge pole 120 to the side pole 110 such that the ridge pole 120 is rotatable and also holds the end poles 112a, 112b detached from the center pole 111.

FIG. 7 corresponds to FIG. 4 and shows the inner surface 20a of the back door 20. The center pole 111 of the side pole 110 is fixed to the inner surface 20a via pole retaining brackets 115a, 115b. The rotary joint 221 is mounted on a center portion of the center pole 111. The rotary joint 221 is rotatable around the axis of the center pole 111. However, the rotatable range of the rotary joint 221 is limited, which will be described later.

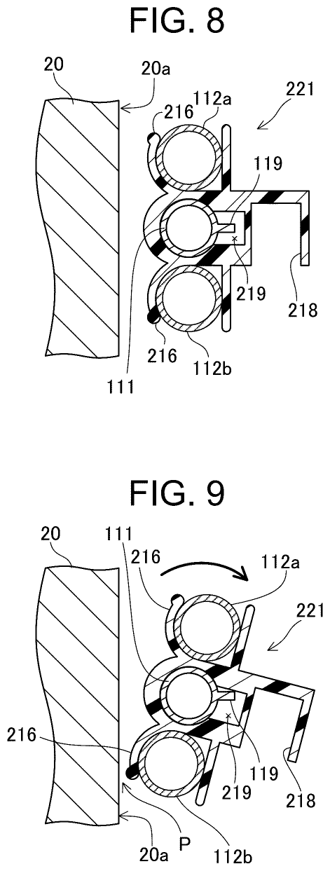

FIGS. 8 and 9 show a cross-sectional view along the line VIII-VIII in FIG. 7. The rotary joint 221 is constituted of a resin, and the rotary joint 221 includes, at its upper and lower portions, holders 216 that hold the end poles 112a, 112b detached from the center pole 111. The holders 216 each have a U shape and hold the end poles 112a, 112b when the end poles 112a, 112b are pushed thereinto.

The rotary joint 221 further includes a hole that allows the ridge pole 120 to be inserted therein and fixes it (insertion hole 218). The rotary joint 221 connects the ridge pole 120 to the side pole 110 such that the ridge pole 120 intersects the side pole 110.

As described above, the rotary joint 221 is rotatable around the axis of the center pole 111 (the side pole 110). As with the rotary joint 121 according to the embodiment, to assemble the tarp set 100, the ridge pole 120 is inserted in the insertion hole 218 of the rotary joint 221 and the ridge pole 120 is rotated toward the latch 30 (see FIG. 6). Once the striker bracket 122 (the hook 123) of the ridge pole 120 engages with the latch 30, the ridge pole 120 is firmly fixed to the back door 20. In FIGS. 7 to 9, the ridge pole 120 connected to the rotary joint 221 is not shown.

Since the center pole 111 is fixed via the pole retaining brackets 115a, 115b, the center pole 111 does not rotate with the rotation of the rotary joint 221. The center pole 111 is provided with a pin 119, and the pin 119 is located inside the rotary joint 221. A movement space 219 is defined inside the rotary joint 221, and the pin 119 is housed therein. As shown in FIGS. 8 and 9, the rotatable range of the rotary joint 221 is limited to a range in which the pin 119 of the center pole 111 can be present within the movement space 219. In other words, the rotatable range of the rotary joint 221 is limited to a range in which the pin 119 does not contact the surfaces defining the movement space 219.

FIG. 9 shows the rotary joint 221 that has been rotated rightward. In FIG. 9, the pin 119 is in contact with the upper surface of the movement space 219, and thus the rotary joint 221 cannot further rotate rightward. In this state, as indicated by the arrow P in FIG. 9, a clearance is secured between the inner surface 20a of the back door 20 and the rotary joint 221 (a holder 216). Similarly, the rotatable range of the rotary joint 221 is also limited by the pin 119 when the rotary joint 221 is rotated leftward, and the rotary joint 221 (a holder 216) does not contact the inner surface 20a of the back door 20. As above, the rotatable range of the rotary joint 221 is limited by the pin 119 of the center pole 111 and the movement space 219 in the rotary joint 221. The rotary joint 221 includes the holders 216 at its upper and lower portions, however, limiting the rotatable range of the rotary joint 221 prevents the holders 216 from contacting the back door 20 (the inner surface 20a).

Points to be noted about the technology described in the embodiment are listed. The tarp set 100 according to the embodiment is easy to assemble, and when assembled, can provide a large shaded area on the sides of and behind the opened back door 20.

The side pole 110 can be divided into three pieces, and the back door 20 can be closed with the center pole 111 attached thereon.

The ridge pole 120 is connectable to the side pole 110 via the rotary joint 121 such that the ridge pole 120 is rotatable in the circumferential direction of the side pole 110. The striker bracket 122 is mounted on an intermediate portion of the ridge pole 120. The distance from the rotation center of the ridge pole 120 to the latch 30 of the back door 20 is equal to the distance from the rotation center to the striker bracket 122 (the hook 123). Thus, the striker bracket 122 (the hook 123) contacts the latch 30 when the ridge pole 120 is rotated rearward and upward. Once the latch 30 is engaged with the striker bracket 122 (the hook 123), the ridge pole 120 is firmly fixed to the back door 20.

In the case where the back door is configured to open and close electrically, the following advantage can be obtained by the engagement of the hook of the striker bracket with the latch in the back door. In the case where the back door is configured to open and close electrically, an actuator may operate in response to a downward load being applied onto the opened back door, and the back door may thereby be automatically closed. This mechanism may be called “easy closer”. A controller of a vehicle may be configured not to activate “easy closer” when the striker is engaged with the latch in the opened back door. The tarp set comprising the striker bracket is used for a vehicle including such a mechanism. The side pole and the ridge pole are attached to the opened back door and then the hook of the striker bracket is brought into engagement with the latch in the back door. This prevents the controller of the vehicle from activating the easy closer and thus prevents the back door with the side pole and the ridge pole attached thereon from automatically closing.

In the side pole 110 of the embodiment, the inner diameter of the end pole 112a (112b) is equal to the outer diameter of the center pole 111, and the end pole 112a (112b) is insertable to an end of the center pole 111, however, the connection of the end poles with the center pole is not limited thereto. For example, projections may extend from ends of the end poles and these projections may fit with the ends of the center pole. In this case, the diameter of the end poles (the diameter of the poles excluding the projections) may be equal to the diameter of the center pole. After the fitting, the outer surfaces of the end poles are flush with the outer surface of the center pole. Alternatively, projections may extend from the ends of the center pole and these projections may fit with ends of the end poles. In this case, the diameter of the center pole (the diameter of the pole excluding the projections) may be equal to the diameter of the end poles. After the fitting, the outer surfaces of the end poles are flush with the outer surface of the center pole.

In the case of end portions of the end poles fitting with the inside of the center pole, radially movable projections may be provided on outer surfaces of the end portions of the end poles. In this case, holes that fit with the projections may be defined on inner surfaces of end portions of the center pole. When the end poles fit with the center pole, the projections on the outer surfaces of the end portions of the end poles fit in the holes in the center pole, which firmly connects the end poles to the center pole.

In the case of end portions of the center pole fitting with the inside of the end poles, radially movable projections may be provided on the outer surfaces of the end portions of the center pole. In this case, holes that fit with the projections may be defined on inner surfaces of end portions of the end poles. When the end poles fit with the center pole, the projections on the outer surfaces of the end portions of the center pole fit in the holes in the end poles, which firmly connects the end poles to the center pole.

The tarp is an abbreviation of “tarpaulin” and means a tarp for camping in particular. The tarp set 100 disclosed in the present description may be called a camping tarp. However, the tarp set disclosed in the present description is useful not only for camping but also in case of disaster. The back door 20 may be called a rear gate or a tail gate. The tarp 130 according to the embodiment may be called a tarp body.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

1. A tarp set mountable to a flip-up back door at a rear portion of a vehicle, the tarp set comprising:
a side pole mountable to an inner surface of the back door when the back door is open and extending in a left-right direction of the vehicle;
a ridge pole extending from the back door in a rear direction of the vehicle; and
a tarp connectable to both ends of the side pole and to a rear end of the ridge pole and hanging down on both sides of the ridge pole.

2. The tarp set of claim 1, wherein the side pole includes a center pole fixable to the back door and a pair of end poles detachably attachable to respective ends of the center pole, and
an entirety of the center pole is located within an outline of the back door.

3. The tarp set of claim 2, further comprising a holder for holding the end poles detached from the center pole along the center pole.

4. The tarp set of any one of claims 1 to 3, further comprising a striker bracket mounted on the ridge pole,
wherein the striker bracket is engageable with a latch located on the back door.

5. The tarp set of claim 4, further comprising a rotary joint for rotatable connection of the ridge pole to the side pole,
wherein the striker bracket engages the latch when the ridge pole is rotated towards the latch.

6. The tarp set of claim 1, further comprising a frame for supporting the tarp, wherein a center of the frame is connectable to the ridge pole and both ends of the frame contact a ground.
